(19) United States
(12) Patent Application Publication
(10) Pub. No.: US 2007/0234629 A1
(43) Pub. Date: Oct. 11, 2007

(54) Self-securing spring bobber

(76) Inventor: Joseph Dean Brooks, Lake Mills, WI (US)

Correspondence Address: MEDLEN & CARROLL, LLP, 101 HOWARD STREET, SUITE 350, SAN FRANCISCO, CA, 94105, US

(21) Appl. No.: 11/702,923

(22) Filed: Feb. 6, 2007

Related U.S. Application Data
(60) Provisional application No. 60/765,569, filed on Feb. 6, 2006.

(51) Int. Cl. A01K 97/12; A01K 85/01; A01K 87/02

(52) U.S. Cl. 43/17

(57) ABSTRACT

The present invention provides compositions for fishing. In particular, the present invention provides a bite indicator that detects the slightest bite of a fish on a hook or bait. The bite indicator is easily attached and removed from a rod by a resilient, self-securing fitting.

This application claims priority to Provisional Patent Application Ser. No. 60/765,569, filed Feb. 6, 2006, which is incorporated herein by reference in its entirety.

### FIELD OF THE INVENTION

The present invention provides compositions for fishing. In particular, the present invention provides a bite indicator that detects the slightest bite of a fish on a hook or bait. The bite indicator is easily attached and removed from a rod by a resilient, self-securing fitting.

### BACKGROUND OF THE INVENTION

A goal of the fishing industry has been to develop very sensitive bite indicators that alert the user when there is even the slightest movement of the hook or bait. Many of the bite indicators are based on a wire device that it attached or somehow mounted to the end of the fishing pole. The slightest pull on the line by a fish causes the wire to flex, thereby signaling to the user that a fish is biting the hook or bait. However, these simple wire systems get bent and damaged and need to be repaired or replaced frequently by the user. If the bite indicators are created from heavier weight wire to try and bypass potential damage, the bite indicator loses sensitivity and negates the purpose of the bite indicator.

Additionally, such devices are often configured to attach only to a particular manufacture of rod, or are permanently mounted on the rod. Spring bobbers requiring glue, adhesives, tape, or heat-shrink tubing cannot be easily removed once installed, and can be easily damaged on the way to and from fishing sites. Examples of different configurations of bite indicators are described in U.S. Pat. Nos. 3,529,375 and 4,020,579, 5,287,646 and 5,735,073. Wilczynski (U.S. Pat. No. 6,125,573), for example, discloses a bite indicator made of wire and rubber components that is attached to a fishing pole and is adjustable such that it has the capability to detect fish of various weights and sizes. However, the bite indicator system disclosed requires a permanent or semi-permanent mounting of a rubber component on the rod itself by wire, glue, screws or like means and therefore requires a time commitment to install on the fishing rod and further becomes a permanent part of the fishing pole unless the user wants to spend more time taking the installed mount off the pole. The bite indicator system of Wilczynski also needs to be installed on the fishing pole prior to using it in ice fishing, as rubber does not tolerate cold temperatures.

Some spring bobbers are have a rigid or semi-rigid fittings (e.g., of rubber or plastic) that have several bumps or ridges in progressively larger diameter, such that the bobber fitting can be popped through the end eyelet of a rod until the eyelet contacts a bump that is too large to fit through the eyelet. See, e.g., the FRABILL PAN POPPER spring bobber. This type of fitting can be used with several different sizes of eyelets but does not work with some eyelets (e.g., the eyelets of some rods are too large or too small to form a secure attachment to the fitting).

What is needed is a sensitive bite indicator that is self-securing on a fishing rod, without the need for additional materials such as adhesives, tapes, heat-shrink tubing, etc., and without the need for alteration of the rod itself (e.g., by crimping the end eyelet), and that is also easily removed from the rod.

### SUMMARY OF THE INVENTION

The present invention relates to a bite indicator that is self-securing to a fishing rod, e.g., and ice fishing rod. In particular, the present invention relates to a spring bobber comprising a spring and a fitting for securing the spring to a fishing rod. In some embodiments, the spring bobber is attached to an eyelet at the tip of a fishing rod, while in some embodiments, it is attached to any eyelet along the rod.

In some embodiments, the bite indicator of the present invention comprises a fitting and a spring, wherein the fitting comprises a resilient compressible portion and a portion comprising a through-bore, wherein a portion of the spring is mounted in the through-bore of the fitting such that a portion of the spring protrudes from at least one end of the through-bore. In some embodiments, the spring comprises a spring coil.

In some embodiments, the resilient compressible portion of the fitting of the bite indicator is the same as the portion comprising a through-bore, while in other embodiments, these portions are separate parts of the fitting.

In some embodiments, the resilient compressible portion of said fitting has the quality of slow-recovery. In preferred embodiments, the resilient compressible portion of the bite indicator comprises viscoelastic foam. In particularly preferred embodiments, the viscoelastic foam has reduced sensitivity to temperature.

As noted above, in some embodiments, the spring comprises a spring coil. In some embodiments, the spring coil has a diameter of less than about 0.125. In preferred embodiments, the spring coil has a diameter of less than about 0.1 inches, while in particularly preferred embodiments, the spring coil has a diameter of about 0.095 inches.

Spring action of the bobber can be altered by the length of spring coil protruding from the end of the fitting. For example, in some embodiments, less than about 3 inches of the spring coil protrudes from the end of the bite indicator, while in some preferred embodiments, less than 2.5 inches of the spring coil protrudes from the end of the bite indicator. In some embodiments, less than 2 inches of the spring coil protrudes from the end of the bite indicator, while in some embodiments, about 1.5 inches of the spring coil protrudes from the end of the bite indicator. In particularly preferred embodiments, the spring coil is adjustably mounted in the through-bore of the fitting, such that the length of the spring protruding from the end of the fitting is adjustable.

In some embodiments, the present invention comprises a fishing rod comprising a handle portion, an eyelet on a shaft portion, and a bite indicator as described herein, wherein the resilient compressible portion of the fitting of the bite indicator is reversibly mounted in the eyelet, and wherein the spring of the bite indicator protrudes from the through-bore of the fitting in a direction extending away from the handle portion. In preferred embodiments, the resilient compressible portion of the fitting has the quality of slow recovery. In particularly preferred embodiments, the fitting comprises or is composed of viscoelastic foam. In still more particularly preferred embodiments, the viscoelastic foam has reduced sensitivity to temperature. In some preferred embodiments, the spring bobber of the present invention is mounted on the fishing rod such that the eyelet of the fishing rod encircles a portion of the spring coil mounted in the through-bore of said fitting, such that a fishing line running through the spring coil simultaneously runs through the fitting and the eyelet. In preferred embodiments, the eyelet is the tip eyelet of a rod having a plurality of eyelets along the shaft.

Embodiments of the invention are described in this summary, and in the Detailed Description of the Invention, below, which is incorporated here by reference. Although the invention has been described in connection with specific embodiments, it should be understood that the invention as claimed should not be unduly limited to such specific embodiments.

### DESCRIPTION OF THE FIGURES

FIG. 1A shows one embodiment of the present invention comprising a fitting 1 with a spring coil 2 mounted in a through-bore 3.

FIG. 1B shows a cross-sectional view of fitting 1, showing through-bore 3.

FIG. 1C shows a schematic diagram of an embodiment of the invention wherein the rotation of the fitting 1 around the spring coil 2 moves the fitting along the long axis of the spring coil, allowing, e.g., adjustment of the length of the spring coil protruding from the front end of the fitting. As used herein the term “front end” refers to the end of the fitting or through-bore that, when mounted on a rod, is pointed away from the handle of the rod, while the “back end” refers to the opposite end of the through-bore.

FIG. 2 shows one embodiment of the bite indicator of the present invention mounted on a fishing rod. Fitting 1 composed of, e.g., slow-recovery foam, once compressed, is inserted through the eyelet 4 on the end of the fishing rod 5, then allowed to expand such that eyelet 4 firmly but engages the expanded fitting 1. Fishing line 6 runs through the fitting 1 mounted in the eyelet 4, and through the spring coil 2 of the bite indicator.

### DETAILED DESCRIPTION OF THE INVENTION

The present invention relates to a bite indicator that is self-securing to a fishing rod, e.g., an ice fishing rod. In particular, the present invention relates to a spring bobber comprising a spring and a resilient compressible fitting for securing the spring coil to the tip of a fishing rod.

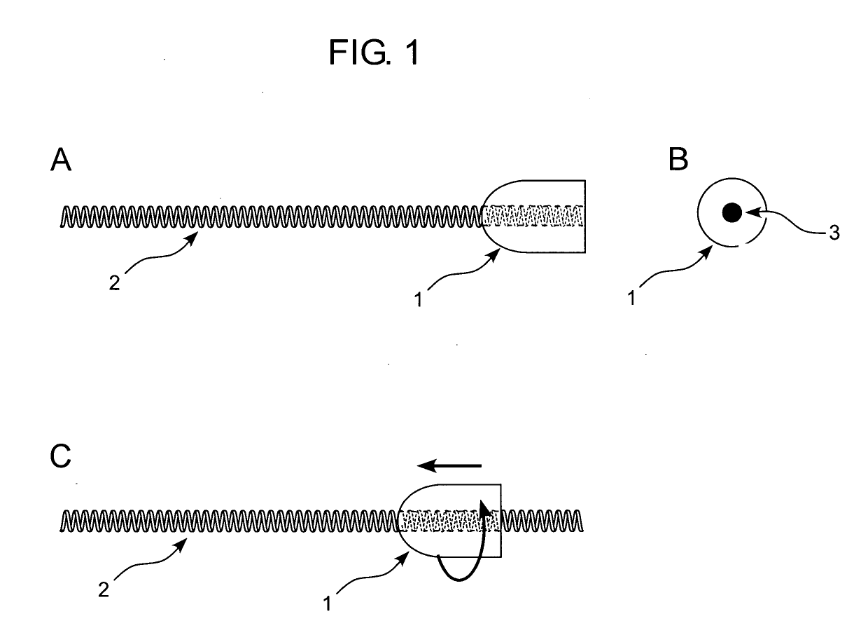

In some embodiments, a bite indicator of the present invention comprises a compressible, self-expanding fitting 1 (see, e.g., FIG. 1), i.e. a resilient compressible fitting. As used herein, the term “resilient compressible” as used in reference to a material or article refers to a material (or an article such as a fitting made of material) that is readily compressible when force is applied to the material, and readily expandable when the compressing force is absent. A compressible material refers to material, e.g., foam or sponge, that is readily compressible to a smaller size (e.g., smaller diameter, thickness, etc.), e.g., for insertion into an opening that is smaller than the uncompressed size of the article. Preferably, a compressible material is readily compressible to at least less than about 90% of its uncompressed dimension, more preferably less than about 80% of its uncompressed dimension, and still more preferably less than about 70%, 60% or 50% of its uncompressed dimension. A resilient compressible material is not limited to materials that regain their full starting dimensions. Those of skill in the art will appreciate that materials offer only partial recovery also find use in the present invention.

In some preferred embodiments, the resilient compressible fitting of the present invention has slow recovery to its uncompressed size (or to a less compressed size) after the compressing force on the fitting is stopped, i.e., it is a “slow recovery” material that does not immediately return to an expanded form. As used herein, the term “slow recovery” is not limited to any particular time period for recovery of an expanded state. For example, in preferred embodiments, a compressed fitting maintains a compressed or partially compressed state for sufficient time to allow it to be slipped into an eyelet on the fishing rod, but recovers sufficiently quickly that the fitting is secured by expansion within the eyelet very shortly thereafter, e.g., within a few seconds.

In some embodiments, the fitting material is foam. In some preferred embodiments, the resilient compressible fitting comprises slow-recovery foam. In some embodiments, the fitting comprises a material selected to have reduced sensitivity to temperature, especially low temperatures, such that the fitting can expand after compression at low temperatures, e.g., below 32° F. (0° C.). As used herein, “reduced sensitivity to temperature” refers to compressible resilient materials that maintain resilience at low temperature. In preferred embodiments, the foam is slow recovery viscoelastic foam. Examples of viscoelastic foams useful in making a bite indicator of the present invention include but are not limited to those described in Hager et al., 2001, J. Cell. Plastics 37:377-397, and those disclosed in U.S. Pat. Nos. 6,734,220, 6,586,485, and 6,391,935, incorporated by reference herein in their entireties.

Viscoelastic foam is capable of remaining malleable at low temperatures, like those present in ice fishing. The foam is easily compressible and expandable, yet it transiently maintains a compressed state for easy insertion into the eyelet of a fishing pole, where it then readily expands to secure the bite indicator to the eyelet. A viscoelastic foam fitting is similarly easy to compress for removal from the eyelet, even at low temperatures. Viscoelastic foam has the capacity to maintain its viscoelasticity over time, thereby allowing for a bite indicator with longevity. Such viscoelastic foam has found utility as earplugs, bed mattresses (e.g., Thermarest® mattresses), pillows and other devices where form-fitting materials are required that return to their uncompressed shape after repeated use, and under a variety of conditions.

A fitting of the present invention is not limited to a fitting composed entirely of compressible material, or of a single type of compressible material. It will be readily appreciated that a fitting configured to be secured by a resilient compressible portion may also comprise one or more portions of non-compressible material (e.g., plastic, metal, rubber), and/or may comprise combinations of different compressible materials.

In some embodiments, the fitting comprises a foam plug. The plug is not limited to any particular shape, and it is contemplated that essentially any cross-sectional shape (e.g., circle, square rectangle, oval, or another geometric shape, or an irregular shape) may be used, so long as the shape can be compressed sufficiently for insertion into an eyelet of a fishing rod, and expanded sufficiently to secure the fitting to the eyelet. In preferred embodiments, the fitting has a circular cross section (e.g., as diagrammed in FIG. 1B) with a diameter of approximately 0.25 to 0.5 inches. In preferred embodiments, the fitting is from about 0.5 to 1.5 inches in length (along the axis of the through-bore), and in particularly preferred embodiments, the fitting is about 0.75 inches in length. However, the fitting of the present invention is not limited to any particular length, and those of skill in the art will appreciate that the different lengths of fitting material can be used as appropriate, e.g., for different size rods, different weights of fishing line and different types of fish.

In some embodiments, the fitting of the present invention comprises a through-bore, e.g., to accommodate a spring. See, e.g., through-bore 3 in FIG. 1B. In preferred embodiments, the through-bore is disposed longitudinally through the body of the fitting. In particularly preferred embodiments, the through-bore is essentially centered with respect to the cross section of the fitting, e.g., as shown in FIG. 1B. The present invention is not limited to a fitting having a centered through-bore, however. Those of skill in the art will appreciate that a fitting can be configured in a number of ways to provide the functions of both attaching the bite indicator to an eyelet of the rod, and to provide a path for the line through a spring such as a spring coil. For example, the fitting may comprise a mounting portion for mounting the bite indicator to the rod, and a through-bore portion comprising an attached spring coil such that the line by-passes the eyelet of the rod and feeds directly into the through-bore and spring coil of the bite indicator.

It is contemplated that the through-bore can be created by a variety of means, including, but not limited to, passing a hot metal wire down the longitudinal center of a fitting, e.g., a foam plug, thereby creating a through-bore. The present invention is not limited by the process or procedure for which the through-bore is made, and those skilled in the art will recognize the various ways in which a through-bore of the present invention can be created within a fitting, e.g., by drilling, punching, melting, etc. In some embodiments, the through-bore is created in an uncompressed fitting, while in other embodiments, the through-bore is created in compressed material (e.g., punching holes in a compressed sheet of viscoelastic foam). In some embodiments, the external shape of the fitting is partially or completely completed prior to addition of a through-bore, while in other embodiments, through-bores are created in material before the material is turned into individual fittings (e.g., a sheet of foam may be punched with numerous through-bore holes before the sheet is cut to produce numerous separate fittings).

In some embodiments, the bite indicator of the present invention further comprises a spring. The bobber of the present invention is not limited to any particular configuration of spring. In some embodiments, the spring comprises a spring coil. However, the invention is not limited to springs having a general coiled structure. For example, a metal or plastic wire or tab (e.g., a flat strip) having flexibility and resiliency similar to a coiled spring and having an opening for receiving a fishing line would find use in the present invention. In some embodiments, a spring may comprise a loop of wire, e.g., as provided in U.S. Pat. No. 5,287,646, which is incorporated herein by reference. In some embodiments, the spring of the present invention combines different structures, e.g. coiled wire sections, straight wire sections, and tab sections.

In some embodiments, the spring is a spring coil, e.g., wire such as steel wire wrapped in a generally coil shape to from a spring (see, e.g., spring coil 2 of FIG. 1A). In preferred embodiments, the spring coil is mounted in a through-bore in a fitting. See, e.g., FIG. 1. In particularly preferred embodiments, the diameter of the spring is selected such that the spring can be rotationally fitted (e.g., screwed into) the through-bore. In particularly preferred embodiments, the position of the spring in the through-bore can be adjusted along the axis of the spring by turning the spring within the fitting, such that the through-bore advances along the spring coil as on the threads of a screw, e.g., as shown schematically in FIG. 1C.

In preferred embodiments, the spring coil is composed of metal, e.g., steel wire. The wire of the spring coil is not limited to any particular gauge or diameter, but is selected to be readily flexible in response to the bite of a fish. In preferred embodiments, the wire is 0.008 inches to 0.02 inches in diameter. In particularly preferred embodiments, the wire is about 0.012 inches in diameter. Similarly, the diameter of the spring coil is not limited to any particular diameter but is selected to readily flexible in response to the bite of a fish and may further be selected based on the length of the spring, the weight of the line to be used, and the type of fish. A small diameter spring ensures little play between the line and the spring around it, such that the fishing line, once agitated or pulled by a fish, will cause essentially immediate bending of the spring. In some embodiments, the diameter of the spring coil is less than about 0.125 inches, while in preferred embodiments, the diameter of the spring coil is less than about 0.1 inches. In particularly preferred embodiments, the spring coil diameter is about 0.095 inches.

The spring coil is not limited to any particular length, but is selected to be long enough to readily flex in response to the bite of a fish, but short enough that it is not overly bent by the weight of the line along. An overly long spring may be sufficiently bent in the absence of a fish bite (e.g., by the weight of the line alone) that the biting of a fish will cause minimal visible agitation of the bobber, reducing its effectiveness at signaling the fish bite. Those of skill in the art will appreciate that different lengths of spring coil can be used to accommodate different weights of line, different targeted fish, etc. In addition, the length of spring protruding from the front end of the bite indicator (e.g., the end pointing away from the handle of the rod) can be adjusted, e.g., by advancing the spring coil through the through-bore in the fitting. In some embodiments, the length of spring coil protruding from the front end of the fitting (measured as coiled) is about 1.5 to 3 inches. In preferred embodiments, the length of spring coil protruding from the front end of the fitting is 2 to 2.5 inches.

In some embodiments, the end of the spring coil that is not mounted in the fitting is highlighted, e.g., with a color (e.g., paint or enamel) such that it is easily seen by the user. For example, fluorescent and neon colors of pink and orange are readily noticeable and useful in the present invention. In preferred embodiments, about ¼ inch to 1 inch of the end of the spring coil is highlighted.

The spring coil can be mounted into the through-bore in the fitting by a variety of means. For example, it is contemplated that the spring coil can be manually screwed into a through-bore for mounting. The spring coil can also be mounted into the through-bore by instrumental means. The present invention is not limited by the process or procedure for mounting a spring coil into a through-bore of the present invention, and those skilled in the art will recognize the various ways in which a spring coil can be mounted into a through-bore. In some embodiments, the spring coil is inserted into the fitting through a bored hole. In some embodiments, the spring coil is mounted into the fitting such that one end of the spring coil is affixed in the fitting and cannot be easily removed, while the other end of the spring coil extends from the fitting. In yet other embodiments, a spring coil is mounted in a fitting that lacks a through-bore, and the through-bore is then created by removing material from inside the spring coil.

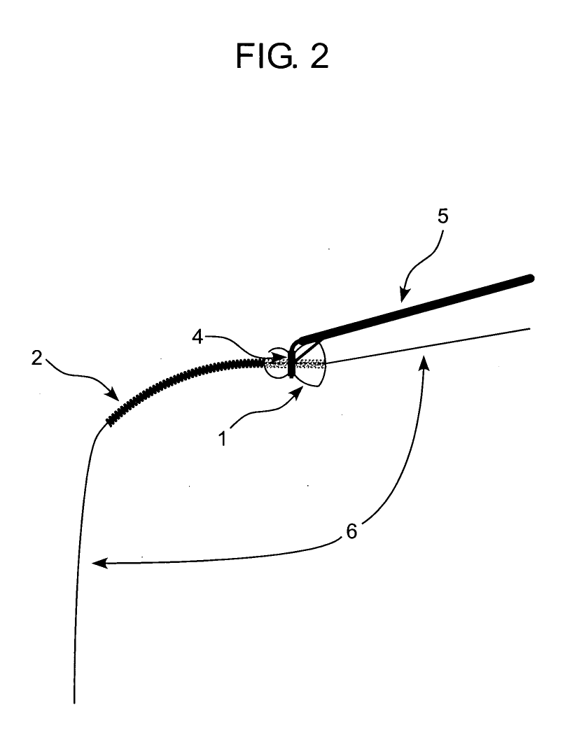

In some embodiments, the bite indicator is attached to a rod by compressing the resilient compressible fitting, inserting the compressed fitting into an eyelet of a fishing pole (e.g., an eyelet on the tip of the shaft), and allowing it to expand, such that it removably affixes itself in the eyelet. A fishing line is passed through the spring coil in the fitting, and the fishing pole becomes a jigging pole that is highly sensitive and readily transmits the force applied to the line to the fisherman at the other end of the pole. One embodiment of a mounted bite indicator of the present invention is diagrammed in FIG. 2. As noted above, the bite indicator is removably affixed, i.e., it can be easily removed without damage to the rod or the bite indicator. The bite indicator is removed, e.g., by compressing the fitting, then withdrawing the fitting from the eyelet.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

I claim:

1. A bite indicator comprising a fitting and a spring, wherein said fitting comprises a resilient compressible portion and a portion comprising a through-bore, wherein a portion of said spring is mounted in said through-bore of said fitting such that a portion of said spring protrudes from at least one end of said through-bore.

2. The bite indicator of claim 1, wherein said spring comprises a spring coil.

3. The bite indicator of claim 1, wherein said resilient compressible portion of said fitting is the portion comprising the through-bore.

4. The bite indicator of claim 1, wherein said resilient compressible portion of said fitting has slow-recovery.

5. The bite indicator of claim 4, wherein said resilient compressible portion comprises viscoelastic foam.

6. The bite indicator of claim 5, wherein said viscoelastic foam has reduced sensitivity to temperature.

7. The bite indicator of claim 2, wherein said spring coil has a diameter of less than about 0.125.

8. The bite indicator of claim 7, wherein said spring coil has a diameter of less than about 0.1 inches.

9. The bite indicator of claim 8, wherein said spring coil has a diameter of about 0.095 inches.

10. The bite indicator of claim 2, wherein less than about 3 inches of said spring coil protrudes from any one end of said through-bore.

11. The bite indicator of claim 10, wherein less than 2.5 inches of said spring coil protrudes from any one end of said through-bore.

12. The bite indicator of claim 11, wherein less than 2 inches of said spring coil protrudes from any one end of said through-bore.

13. The bite indicator of claim 12, wherein about 1.5 inches of said spring coil protrudes from any one end of said through-bore.

14. The bite indicator of claim 2, wherein said spring is adjustably mounted in said through-bore of said fitting such that the length of said spring coil protruding from said end of said through-bore is adjustable.

15. A fishing rod comprising a handle portion, an eyelet on a shaft portion, and the bite indicator of claim 1, where said resilient compressible portion of said fitting of said bite indicator is removably mounted in said eyelet, and wherein a portion of said spring of said bite indicator protrudes from the through-bore of said fitting in a direction extending away from said handle portion.

16. The fishing rod of claim 15, wherein said resilient compressible portion of said fitting has slow recovery.

17. The fishing rod of claim 16, wherein said resilient compressible portion of said fitting comprises viscoelastic foam.

18. The fishing rod of claim 17, wherein the said eyelet of said fishing rod encircles a portion of said spring coil mounted in said through-bore of said fitting.

19. The fishing rod of claim 15, wherein said fishing rod comprises a plurality of eyelets along said shaft portion, and wherein said bite indicator is mounted on the eyelet furthest from said handle portion.
